(19) United States
(12) Patent Application Publication
(10) Pub. No.: US 2022/0374789 A1
(43) Pub. Date: Nov. 24, 2022

(54) INFORMATION PROCESSING DEVICE, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Yuta Tone, Nagoya-shi (JP); Yukinori Ii, Toyota-shi (JP); Tadayuki Tanaka, Nagoya-shi (JP); Naoki Ishizuka, Nagoya-shi (JP); Yuichiro Yano, Nagakute-shi (JP); Nariaki Amano, Nagoya-shi (JP); Yusuke Maeda, Miyoshi-shi (JP); Kei Yazaki, Okazaki-shi (JP); Yu Hamada, Nagoya-shi (JP)

(73) Assignee: TOYOTA JIDOSHA KABUSHIKI KAISHA, Toyota-shi (JP)

(21) Appl. No.: 17/729,195

(22) Filed: Apr. 26, 2022

(30) Foreign Application Priority Data
May 24, 2021 (JP) 2021-087228

(51) Int. Cl. G06Q 10/02

(52) U.S. Cl. CPC G06Q 10/02

(57) ABSTRACT

An information processing device includes a control unit that acquires a request from a first user to move a component included in a first vehicle from the first vehicle and determines, in response to a request from a second user to move the component to a second vehicle, a possible reservation time of a predetermined facility at which the component is to be moved based on the request from the first vehicle.

### CROSS-REFERENCE TO RELATED APPLICATION

This application claims priority to Japanese Patent Application No. 2021-087228 filed on May 24, 2021, incorporated herein by reference in its entirety.

### BACKGROUND

### 1. Technical Field

The present disclosure relates to an information processing device, an information processing method, and a non-transitory storage medium.

### 2. Description of Related Art

It is well known that software is updated in an electronic control unit (ECU) mounted on a vehicle (for example, WO 2019/009020).

### SUMMARY

The present disclosure is intended to facilitate movement of a component between vehicles.

A first aspect of the present disclosure is an information processing device including a control unit configured to acquire a request from a first user to move a component included in a first vehicle from the first vehicle, and determine, in response to a request from a second user to move the component to a second vehicle, a possible reservation time of a predetermined facility at which the component is moved based on the request from the first vehicle.

In the first aspect, the control unit may generate a paring of the first vehicle and the second vehicle.

In the first aspect, the control unit may generate information on a first reservation for reserving the predetermined facility at which the component is to be moved from the first vehicle, and generate information on a second reservation for reserving the predetermined facility at which the component is to be moved to the second vehicle.

In the first aspect, the control unit may generate the information on the first reservation and the information on the second reservation such that the first reservation is earlier than the second reservation.

In the first aspect, the control unit may generate information on a charge for the second user such that the charge for the second user increases as a time period gets longer. The time period is from an end point of a time frame corresponding to the first vehicle to a starting point of a time frame corresponding to the second vehicle.

In the first aspect, the information processing device may further include a storage unit that stores information on the predetermined facility corresponding to removal of the component from the first vehicle and installation of the component in the second vehicle.

In the first aspect, the storage unit may store the possible reservation time of the predetermined facility.

In the first aspect, the storage unit may store a time required for removing the component from the first vehicle and a time required for installing the component in the second vehicle.

In the first aspect, the component increases a performance of the second vehicle after the component is moved to the second vehicle in comparison to before the component is moved to the second vehicle.

In the first aspect, the component may be a component installed in the first vehicle when the first vehicle is manufactured.

In the first aspect, the component may be a component that is selectable as a factory-installed option when the first vehicle is purchased as a new vehicle.

An information processing method according to a second aspect of the present disclosure is performed by a computer. The information processing method includes acquiring a request from a first user to move a component included in a first vehicle from the first vehicle, and determine in response to a request from a second user to move the component to a second vehicle, a possible reservation time of a predetermined facility at which the component is to be moved from the first vehicle.

In the second aspect, the computer may generate a paring of the first vehicle and the second vehicle.

In the second aspect, the computer may generate information on a first reservation for reserving the predetermined facility at which the component is to be moved from the first vehicle, and generate information on a second reservation for reserving the predetermined facility at which the component is to be moved to the second vehicle.

In the second aspect, the computer may generate the information on the first reservation and the information on the second reservation such that the first reservation is earlier than the second reservation.

In the second aspect, the computer may generate information on a charge for the second user such that the charge for the second user increases as a time period gets longer. The time period is from an end point of a time frame corresponding to the first vehicle to a starting point of a time frame corresponding to the second vehicle.

In the second aspect, the component may be a component installed in the first vehicle when the first vehicle is manufactured.

In the second aspect, the component may be an optional component that is selectable as a factory-installed option when the first vehicle is purchased as a new vehicle.

A third aspect of the present disclosure is a non-transitory storage medium storing instructions that are executable by one or more processors and that cause the one or more processors to perform functions. The functions include acquiring a request from a first user to move a component included in a first vehicle from the first vehicle and determining, in a response to a request from a second user to move the component to a second vehicle, a possible reservation time of a predetermined facility at which the component is to be moved based on the request from the first vehicle.

In the third aspect, the component may be a component installed in the first vehicle when the first vehicle is manufactured.

With each aspect of present disclosure, movement of a component between vehicles can be facilitated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration example of a system according to an embodiment of the present disclosure;

FIG. 2 is a block diagram schematically illustrating each exemplified configuration of a server, a user terminal and a facility terminal, which compose the system according to the embodiment;

FIG. 3 is a diagram illustrating a functional configuration of the server;

FIG. 4 is a diagram illustrating a table configuration of component information stored in a component information database;

FIG. 5 is a diagram illustrating a table configuration of facility information stored in a facility information database;

FIG. 6 is a diagram illustrating a table configuration of sale information stored in a sale information database;

FIG. 7 is a diagram illustrating a table configuration of purchase information stored in a purchase information database;

FIG. 8 is a diagram illustrating a table configuration of reservation information stored in a reservation information database;

FIG. 9 is a diagram illustrating a functional configuration of a user terminal;

FIG. 10 is a diagram illustrating a functional configuration of a facility terminal;

FIG. 11 is a sequence diagram illustrating the entire processing of the system;

FIG. 12 is a flowchart of a reservation process in the server according to a first embodiment;

FIG. 13 is a flowchart illustrating a flow of a paring generation process executed in step S102;

FIG. 14 is a flowchart illustrating a flow of a facility selection process executed in step S105;

FIG. 15 is a diagram illustrating one example of a facility list;

FIG. 16 is a diagram illustrating one example of a sale list;

FIG. 17 is a sequence diagram illustrating the entire processing of the system;

FIG. 18 is a flowchart of a process when a server according to a second embodiment receives a sale request;

FIG. 19 is a flowchart of a process when the server according to the second embodiment receives a purchase request; and

FIG. 20 is a flowchart of a process executed in a server according to a third embodiment.

### DETAILED DESCRIPTION OF EMBODIMENTS

An information processing device according to one aspect of the present disclosure includes a control unit that acquires a request from a first user to move a component included in a first vehicle from the first vehicle, and determines, when a second user sends a request to move the component to a second vehicle, a possible reservation time of a predetermined facility at which the component is to be moved based on the request from the first vehicle.

The first vehicle may be, for example, a vehicle owned by the first user. The second vehicle may be, for example, a vehicle owned by the second user. For example, in a case where the first user wants to sell a component included in the first vehicle, a request to move the component from the first vehicle may be sent from a terminal possessed by the first user. Further, for example, in a case where the second user wants to purchase and install the component in the vehicle, a request to move the component to the second vehicle may be sent from a terminal possessed by the second user.

An example of the component is a device or a part fixed to the first vehicle. Examples of the component can include software. Further, the component may be a component that is difficult for an average user to move to another vehicle. When the component is removed from the first vehicle or installed in the second vehicle, for example, in a case where vehicle disassembly, a special tool, or software update is required, it is difficult for the first user or the second user to carry out tasks by themselves.

When the component is moved from the first vehicle, for example, it is necessary to remove the component fixed to the first vehicle from the first vehicle. Further, when the component is moved from the first vehicle, it may be necessary to, for example, wipe the software installed in the first vehicle, or cancel a license to use software or hardware installed in the first vehicle.

When the component is moved to the second vehicle, it is necessary to fix the component to the second vehicle, and to install the component in the second vehicle. Further, when the component is moved to the second vehicle, it may be necessary to, for example, install the software in the second vehicle, or grant a license to use software or hardware installed in the second vehicle.

A predetermined facility may, for example, have tools capable of moving components between vehicles and workers who can move the components. Even when components are difficult for a user to replace, it is possible to move the components from the first vehicle to the second vehicle in the predetermined facility.

The control unit determines a possible reservation time based on the request from the first user when the second user sends the request to move the component to the second vehicle. The possible reservation time may include different dates and times. Further, the control unit may make a reservation according to a determined time, or may have the second user select a time when they want to make a reservation from several determined possible reservation times. The possible reservation time for the request from the second user is determined based on the request from the first user. In a case where the component is moved from the first vehicle to the second vehicle, the component is removed from the first vehicle before being moved to the second vehicle. Therefore, for example, the possible reservation time may be determined such that the component can be moved to the second vehicle after the component is removed from the first vehicle.

The user of the second vehicle may move the component to the second vehicle at the predetermined facility at the reserved time. In other words, it is possible to move the component from the first vehicle to the second vehicle at the predetermined facility.

For example, the component can be sold by a user who wants to sell the component and purchased by a user who wants to purchase the component. In other words, the component can be sold and purchased by generating a paring of the first vehicle and the second vehicle. Accordingly, movement of a component between vehicles can be facilitated.

Hereinafter, embodiments of the present disclosure will be described with reference to the drawings. Configurations of the following embodiments are merely examples, and the present disclosure is not limited to those configurations of the embodiments. Further, the following embodiments can be combined as much as possible.

### First Embodiment

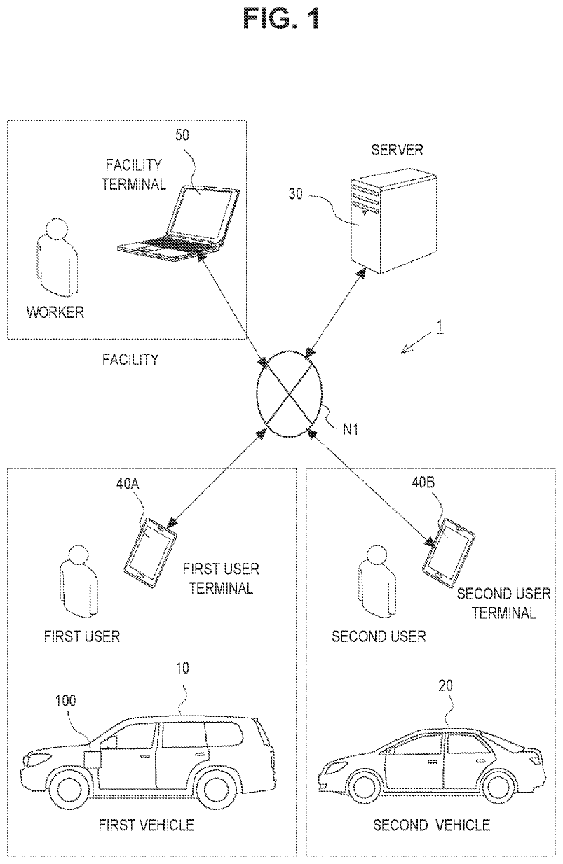

FIG. 1 is a diagram illustrating a schematic configuration example of a system 1 according to an embodiment of the present disclosure. In the example of FIG. 1, the system 1 includes a server 30, a first user terminal 40A, a second user terminal 40B, and a facility terminal 50. The system 1 is a system that makes a reservation of a service for moving a component 100 from a first vehicle 10 to a second vehicle 20 in a facility. The first vehicle 10 is a vehicle owned by the first user, and the second vehicle 20 is a vehicle owned by the second user. The first vehicle 10 is a vehicle originally provided with the component 100. Meanwhile, the second vehicle 20 is a vehicle without the component 100. The second vehicle 20 may be provided with a component which can be replaced with the component 100 but has a poorer performance than that of the component 100. The component 100 can, for example, enhance the performance of the second vehicle 20 when it is installed in the second vehicle 20.

Higher performance means higher properties or capabilities, or better appearance. For example, it is assumed that an old seat of the second vehicle 20 may be replaced with a new seat of the same type, which is installed in the first vehicle 10, or a fabric seat of the second vehicle 20 may be replaced with a genuine leather seat installed in the first vehicle 10. Further, for example, it is assumed that the component 100 may be a sunroof moved from the first vehicle 10 to the second vehicle 20. Moreover, for example, it is assumed that the component 100 mounted on a first vehicle 10 that has undergone a facelift or is a brand new may be moved to the second vehicle 20 before introducing a facelift or model change.

Examples of the component 100 include advanced safety systems (including but not limited to a collision mitigation brake, a false start restriction controller, a V2V driving control unit, a lane-keeping system, a side/rear vehicle detection system, and an automatic headlight switch). For example, in a case where the first vehicle 10 is equipped with an up-to-date advanced safety system and the second vehicle 20 is equipped with an advanced safety system that is one generation old, it is possible to enhance the performance of the second vehicle 20 by removing the up-to-date system from the first vehicle 10 and installing it in the second vehicle 20. Similarly, for example, in a case where the first vehicle 10 is equipped with an advanced safety system that is one generation old and the second vehicle 20 is equipped with an advanced safety system that is two generations old, it is possible to enhance the performance of the second vehicle 20 by removing the system one that is generation old from the first vehicle 10 and installing it in the second vehicle 20. In this case, the advanced safety system that is one generation old may have been discontinued already, or it may be difficult to newly install the advanced safety system that is one generation old but a used part necessary for installation can be obtained.

In the embodiment, the component 100 is described as a physical component, but a virtual component, such as software, can be similarly applied. Further, for example, an ECU that controls the vehicle can be applied. In this case, the hardware may be replaced or only the software may be moved. Further, the software may be made available or downloadable in the second vehicle 20 by transferring a license to use the software from the first vehicle 10 to the second vehicle 20.

Further, the component 100 may be, for example, a component which was selected from factory-installed options to be equipped in the first vehicle 10 when purchasing the first vehicle 10 as a new vehicle, or a component which was equipped in the first vehicle 10 as a default component when the first vehicle 10 was manufactured. The component selected from the factory-installed options is installed in the first vehicle 10 during, for example, a manufacturing process of the first vehicle 10 by an automobile manufacturer. Therefore, it may be difficult to mount the component 100 after the vehicle is completed when such a component is selected from factory-installed options. With the present embodiment, it is possible to replace such a component 100.

An example of the facility that replaces the component 100 is an automobile manufacturer, an automobile maintenance factory, an automobile repair shop, an automobile dealer, an automobile parts dealer, an automobile accessory dealer, or a hardware store. An example of the workers is mechanics or facility employees.

The first user sends, by using the first user terminal 40A, a request to the server 30 to remove the component 100. Further, the first user is also a user who wishes to sell the component 100. On the other hand, the second user sends, by using the second user terminal 40B, a request to the server 30 to install the component 100. The second user is also a user who wishes to purchase the component 100. The first user terminal 40A may be a terminal possessed by the first user, or may be a terminal held by an automobile dealer. The second user terminal 40B may be a terminal held by the second user, or may be a terminal held by an automobile dealer. Further, in a case where the first user terminal 40A and the second user terminal 40B are not particularly distinguished, they are simply referred to as the “user terminal 40”. Further, in a case where the first user and the second user are not particularly distinguished, they are simply referred to as the “user”. The same terminal may serve as the first user terminal 40A when the component 100 is removed, and as the second user terminal 40B when the component 100 is installed.

The first user who sends a request to remove the component 100 may be, for example, an owner of the first vehicle 10, or an employee of the automobile dealer contacted by the owner. The second user who sends a request to install the component 100 may be, for example, an owner of the second vehicle 20, or the employee of the automobile dealer contacted by the owner.

The server 30 determines, for example, to connect the first vehicle 10 of the first user who wants to sell and remove the component 100 with the second vehicle 20 of the second user who wants to purchase and install the component 100 according to the request from the user terminal 40. For example, the server 30 determines to connect the first vehicle 10 to the second vehicle 20 based on information on the component 100, a selling price offered by the first user, a purchase price offered by the second user, and a location of each user. The server 30 makes a reservation for the facility terminal 50 at which the component 100 will be removed from the first vehicle 10 and installed in the second vehicle 20.

At the time reserved for removing the component 100 from the first vehicle 10, the first user brings the first vehicle 10 to the facility. The worker removes the component 100 at the facility. A substitute component may be installed in the first vehicle 10 from which the component 100 has been removed. The substitute component may be, for example, a cover covering an opening of a space from which the component 100 has been removed. The first vehicle 10 from which the component 100 has been removed is taken away from the facility by the first user. The removed component 100 is stored in the facility. The first user may pay the facility a fee for removal of the component 100 and a storage fee for retainment of the component 100. These charges may be determined in advance according to, for example, the component 100.

At the time reserved for installing the component 100 to the second vehicle 20, the second user brings the second vehicle 20 into the facility, and the worker installs the component 100 in the facility. When the component 100 is installed in the second vehicle 20, the second vehicle 20 is taken away from the facility by the second user. The second user may pay the facility a fee for installation of the component 100 and a storage fee for retaining the component 100. These charges may be determined in advance according to, for example, the component 100. Further, for example, the second user may pay a price of the component 100 to the first user via the facility or the server 30. Alternatively, the price of the component 100 may be directly transferred from the second user terminal 40B to the first user terminal 40A in a form of digital currency.

Accordingly, the second user can improve the performance of the second vehicle 20 by installing the component 100 in the second vehicle 20. The first user can sell the used component 100 to obtain a profit. Further, when the component 100 is a component installed during manufacture of the vehicle, it may be difficult for the user to replace it, but even such a component can be replaced by the worker at the facility.

The server 30, the first user terminal 40A, the second user terminal 40B, and the facility terminal 50 are connected to each other by a network N1. The network N1 may be, for example, a worldwide public communication network, such as the Internet, and a wide area network (WAN) or other communication networks. Further, the network N1 may include a telephone communication network, such as a mobile phone, and a wireless communication network, such as WiFi®.

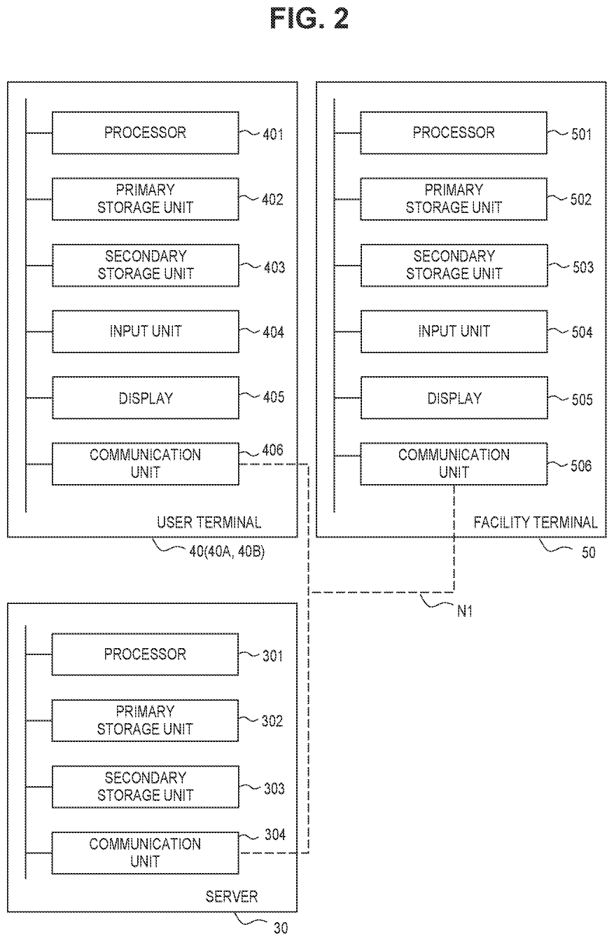

Referring to FIG. 2, hardware configurations of the server 30, the user terminal 40, and the facility terminal 50 will be described. FIG. 2 is a block diagram schematically illustrating each exemplified configuration of the server 30, the user terminal 40, and the facility terminal 50, which compose the system 1 according to the embodiment.

The server 30 is configured by a general computer. The server 30 provides services to users and workers. The server 30 includes a processor 301, a primary storage unit 302, a secondary storage unit 303, and a communication unit 304. These components are connected to each other by buses. The server 30 is one example of the information processing device. The processor 301 is one example of the “control unit”. The primary storage unit 302 or the secondary storage unit 303 is one example of the storage unit.

The processor 301 may be a central processing unit (CPU), a digital signal processor (DSP), or the like. The processor 301 controls the server 30 and performs various information processing calculations. The primary storage unit 302 is a random access memory (RAM), a read-only memory (ROM), or the like. The secondary storage unit 303 may be an erasable programmable ROM (EPROM), a hard disk drive (HDD), a removable medium, or the like. The secondary storage unit 303 stores an operating system (OS), various programs, various tables, and the like. The processor 301 loads the program stored in the secondary storage unit 303 into a working area of the primary storage unit 302 and performs such a program. Each component is controlled by performing the program. Consequently, the server 30 implements a function that matches a predetermined purpose. The primary storage unit 302 and the secondary storage unit 303 are computer-readable storage media. Further, the server 30 may be a single computer or a paring of computers. Additionally, the information stored in the secondary storage unit 303 may be stored in the primary storage unit 302. Further, the information stored in the primary storage unit 302 may be stored in the secondary storage unit 303.

The communication unit 304 is a unit configured to communicate with the user terminal 40 and the facility terminal 50 via the network N1. The communication unit 304 may be, for example, a local area network (LAN) interface board or a wireless communication circuit for wireless communication. The LAN interface board and the wireless communication circuit are connected to the network N1.

Next, the user terminal 40 will be described. An example of the user terminal 40 is a small computer, such as a smartphone, a mobile phone, a tablet terminal, a personal information terminal, a wearable computer (such as a smart watch), or a personal computer (PC). The first user terminal 40A and the second user terminal 40B have the same configuration.

The user terminal 40 includes a processor 401, a primary storage unit 402, a secondary storage unit 403, an input unit 404, a display 405, and a communication unit 406. These components are connected to each other by buses. In a case where the first user terminal 40A and the second user terminal 40B are particularly distinguished, the first user terminal 40A includes a processor 401A, a primary storage unit 402A, a secondary storage unit 403A, an input unit 404A, a display 405A, and a communication unit 406A, while the second user terminal 40B includes a processor 401B, a primary storage unit 402B, a secondary storage unit 403B, an input unit 404B, a display 405B, and a communication unit 406B. As described above, alphabet letter “A” is attached to the reference sign for a configuration of the first user terminal 40A, and alphabet letter “B” is attached to the reference sign for a configuration of the second user terminal 40B. The processor 401, the primary storage unit 402, and the secondary storage unit 403 of the user terminal 40 are the same as the processor 301, the primary storage unit 302, and the secondary storage unit 303 of the server 30, and thus descriptions thereof will be omitted.

The input unit 404 is a unit that receives an input operation performed by the user, and may be, for example, a touchscreen, a mouse, a keyboard, or a microphone. The display 405 is a unit that presents information to the user, and may be, for example, a liquid crystal display (LCD), or an electroluminescence (EL) panel. The input unit 404 and the display 405 may be configured as a single touchscreen display.

The communication unit 406 is a communication unit that allows the user terminal 40 to access the network N1. The communication unit 406 is a circuit used for performing communication with other devices (for example, the server 30) via the network N1 using, for example, a mobile communication service (telephone communication network, such as Fifth Generation (5G), Fourth Generation (4G), Third Generation (3G) or long term evolution (LTE), or a wireless communication network, such as Wi-Fi®).

Next, the facility terminal 50 will be described. The facility terminal 50 may be, for example, a small computer, such as a smartphone, a mobile phone, a tablet terminal, a personal information terminal, a wearable computer (such as a smart watch), or a personal computer (PC).

The facility terminal 50 includes a processor 501, a primary storage unit 502, a secondary storage unit 503, an input unit 504, a display 505, and a communication unit 506. These components are connected to each other by buses. The processor 501, the primary storage unit 502, the secondary storage unit 503, the input unit 504, the display 505, and the communication unit 506 of the facility terminal 50 are the same as the processor 401, the primary storage unit 402, the secondary storage unit 403, the input unit 404, the display 405, and the communication unit 406 of the user terminal 40, and thus descriptions thereof will be omitted.

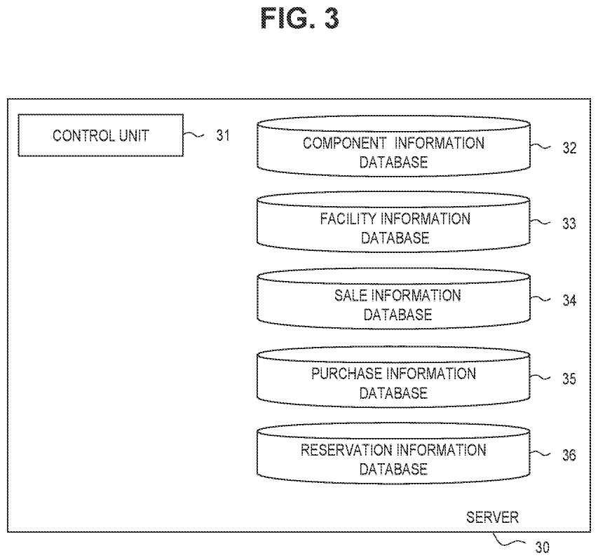

Next, functions of the server 30 will be described. FIG. 3 is a diagram illustrating a functional configuration of the server 30. The server 30 includes a control unit 31, a component information database 32, a facility information database 33, a sale information database 34, a purchase information database 35, and a reservation information database 36 as functional components. The processor 301 of the server 30 performs the processing of the control unit 31 by a computer program on the primary storage unit 302. A part of the processing of the control unit 31 may be executed by another computer connected to the network N1.

The component information database 32, the facility information database 33, the sale information database 34, the purchase information database 35, and the reservation information database 36 are respectively constructed by managing data stored in the secondary storage unit 303 by a database management system (DBMS) program executed by the processor 301. The component information database 32, the facility information database 33, the sale information database 34, the purchase information database 35, and the reservation information database 36 may be, for example, a relational database.

The control unit 31 receives a request from the first user terminal 40A to sell and remove the component 100 included in the first vehicle 10. Hereinbelow, this request is also referred to as a sale request. The sale request includes information required for the control unit 31 to reserve the facility and information required for combining the first vehicle 10 with the second vehicle 20. The sale request includes, for example, information that can identify the first user (a user ID), information on an area where the first user wants to remove the component 100, information on the component 100, information on the first vehicle 10, information on a selling price of the component 100, information on a state of the component 100, and information on the date and time when the first user wants to remove the component 100.

The user ID is given to the user by the server 30 in advance. The user ID is an identification that can be used for both selling and purchasing. The information on the area may be information based on an administrative division where the first user wants to remove the component 100, or may be information divided by a mesh. Alternatively, the information on the area may be information on a location of the first user, for example, an address of the first user. A predetermined area including the location of the first user may be an area where the first user wants to replace the component 100.

An example of the information on the first vehicle 10 is information on a vehicle type, a color, and a grade of the first vehicle 10. An example of the information on the selling price of the component 100 is the selling price of the component 100 desired by the first user. An example of the information on the state of the component 100 is information on scratches or stains on the component 100, which can be specified via five levels from level 1 to level 5. For example, “5” indicates the best condition and “1” indicates the worst condition. The state of the component 100 is determined by the first user according to criteria determined in advance. Alternatively, the server 30 may determine the state of the component 100 based on answers that the first user gives to questions presented by the server 30.

The information on the date and time when it is desired that the component 100 be removed is information on the date and time when the first user wants to remove the component 100. The date and time when the first user wants to remove the component 100 may include several dates and times. Further, the date and time when the first user wants to remove the component 100 may be selected from a time frame determined in advance. The sale request including these pieces of information is transmitted from the first user terminal 40A to the server 30. When receiving the sale request, the control unit 31 stores the information included in the sale request in the sale information database 34, which will be described below.

Further, the control unit 31 receives a request from the second user terminal 40B to purchase and install the component 100. Hereinbelow, this request is also referred to as a purchase request. The purchase request includes information required for the control unit 31 to reserve the facility and information required for combining the second vehicle 20 with the first vehicle 10. The purchase request includes, for example, information that can identify the second user (a user ID), information on an area where the second user wants to install the component 100, information on the component 100, information on the second vehicle 20, information on a purchase price of the component 100, information on the state of the component 100, and information on the date and time when the second user wants to install the component 100.

The information on the area may be information based on an administrative division where the second user wants to install the component 100, or may be information divided by a mesh. Alternatively, the information on the area may be information on a location of the second user, for example, an address of the second user. A predetermined area including the location of the second user may be an area where the second user wants to install the component 100.

An example of the information on the second vehicle 20 is information on a vehicle type, a color, and a grade of the second vehicle 20. An example of the information on the purchase price of the component 100 is the purchase price of the component 100 desired by the second user. The purchase price may have a certain range. An example of the information on the state of the component 100 is information on a state on the component 100 that the second user wants to purchase, which is specified via five levels from level 1 to level 5 similar to that of the sale request. The state of the component 100 according to the purchase request may have a certain range. For example, several limitations desired by the second user may be included.

The information on the date and time when it is desired that the component 100 be installed is information on the date and time when the second user wants to install the component 100. The date and time when the second user wants to install the component 100 may include several dates and times. Further, the date and time when the second user wants to install the component 100 may be selected from a time frame determined in advance. The purchase request including these pieces of information is transmitted from the second user terminal 40B to the server 30. When receiving the purchase request, the control unit 31 stores the information included in the purchase request in the purchase information database 35, which will be described below.

The control unit 31 generates a paring of the first vehicle 10, the second vehicle 20, and the facility. The control unit 31 compares the area, the component ID, the selling price, the state, and the desired date and time, which are stored in the sale information database 34, with the area, the component ID, the purchase price, the state, and the desired date and time, which are stored in the purchase information database 35. The control unit 31 generates a paring of the first vehicle 10 and the second vehicle 20 such that the area, the component ID, the selling price, and the state which are stored in the sale information database 34 match the area, the component ID, the purchase price, and the state which are stored in the purchase information database 35, and the desired date and time stored in the sale information database 34 are earlier than the desired date and time stored in the purchase information database 35. The number of parings can be plural.

Further, the area, the component ID, the selling price, and the state which are stored in the sale information database 34 do not have to completely match the area, the component ID, the purchase price, and the state which are stored in the purchase information database 35. For example, different areas may be acceptable to the user. For example, the first user may be able to move to a farther area when the component 100 can be sold at a good price. Similarly, the second user may be able to move to a farther area when the component 100 can be purchased cheaper. Further, for example, even when the selling price is different from the purchase price, the first user or the second user may reach an agreement. Therefore, a paring may be generated in which the first user and the second user are asked to confirm the paring and accept a deal.

Further, the control unit 31 selects a facility capable of accepting a reservation to remove and install the component 100 based on the selected paring of the first vehicle 10 and the second vehicle 20. The control unit 31 receives information on a possible reservation date and time from the facility terminal 50 at any time. The possible reservation date and time is a date and time when no reservation is made and the component 100 can be removed and installed. The information on the possible reservation date and time is input in the facility terminal 50 by, for example, a worker, and is transmitted from the facility terminal 50 to the server 30. The information on the facility is stored in the facility information database 33. The facility information database 33 will be described below.

The control unit 31 selects a facility by determining whether there is an available time when the facility can deal with removal and installation of the component 100. The time required for replacing the component 100 is stored in the component information database 32. The component information database 32 will be described below. When the facility is selected, the control unit 31 generates information for making a reservation for the facility at which the component 100 is moved from the first vehicle 10 to the second vehicle 20. The control unit 31 then transmits the generated information to the facility terminal 50. The information transmitted to the facility terminal 50 at this time includes information on the first user, the second user, the component 100, the first vehicle 10, the date and time when the component 100 is removed from the first vehicle 10, the second vehicle 20, and the date and time when the component 100 is installed in the second vehicle 20. The information on the first user and the second user may include information on a name and contact details of each user (such as a telephone number or an e-mail address).

Further, when the facility is selected, the control unit 31 transmits, to the user terminal 40, information indicating that the reservation is made. At this time, the control unit 31 transmits the information on the facility and the information on the date and time when the component 100 is removed (a removal date) to the first user terminal 40A. Furthermore, the control unit 31 transmits the information on the facility and the information on the date and time when the component 100 is installed (an installation date) to the second user terminal 40B. Moreover, when the reservation is made, the control unit 31 stores information on the reservation (hereinafter, also referred to as “reservation information”) in the reservation information database 36. The reservation information database 36 will be described below.

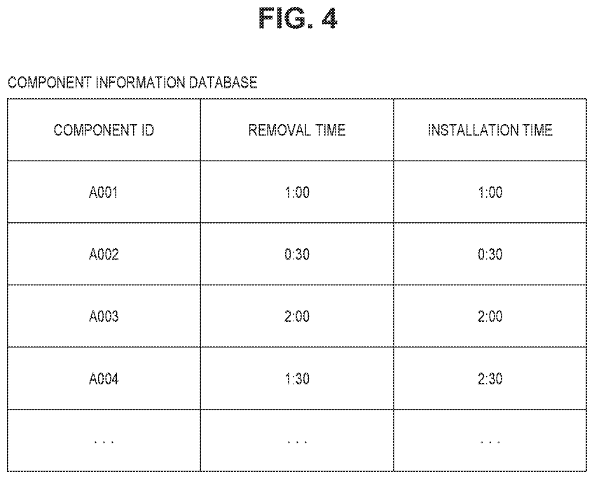

FIG. 4 is a diagram illustrating a table configuration of component information stored in the component information database 32. The component information database 32 is a database used by the control unit 31 to search for a time required for installing and removing the component 100. A component information table has fields of component ID, time required for removal (a removal time), and time required for installation (an installation time). Information for identifying the component 100 (the component ID) is input in a component ID field. The component ID is assigned to each component 100 by the control unit 31. Information on the time required to remove the component 100 is input in a removal time field. Information on the time required to install the component 100 is input in an installation time field. The installation time and the removal time may be represented in standard workloads. Further, even when the component 100 is the same, the installation time and the removal time may be different depending on a vehicle type, and thus the component ID may be set for each vehicle type. Each piece of information stored in the component information database 32 is input in advance by, for example, an administrator of the server 30 or the worker of the facility.

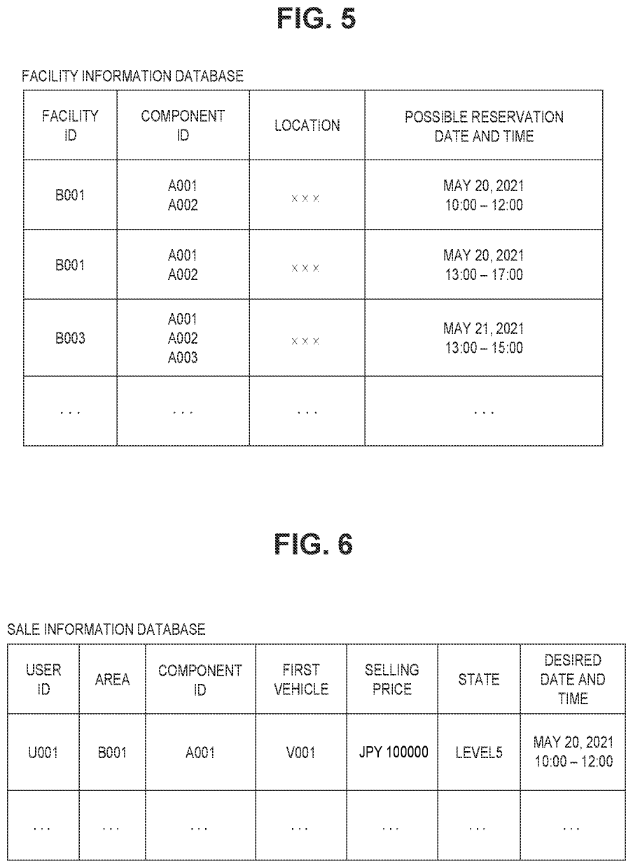

FIG. 5 is a diagram illustrating a table configuration of facility information stored in the facility information database 33. The facility information database 33 is a database used by the control unit 31 to search for the facility that can deal with the component 100. A facility information table has fields of facility ID, component ID, location, and possible reservation date and time. Information for identifying the facility (a facility ID) is input in a facility ID field. The facility ID is assigned to each facility by the control unit 31. Information for identifying the component 100 (component ID) that is removed and installed at the facility is input in a component ID field. Information on the location of the facility (e.g., information on address, area, grid square code, or coordinates) is input in a location field. Information on the date and time when the component 100 can be removed or installed at the facility is input in a possible reservation date and time field. The information on the possible reservation date and time may be transmitted from the facility terminal 50 at predetermined time intervals, may be transmitted from the facility terminal 50 when a predetermined input is made to the facility terminal 50, and may be transmitted from the facility terminal 50 as requested by the control unit 31. The possible reservation date and time may be represented in a time frame.

FIG. 6 is a diagram illustrating a table configuration of sale information stored in the sale information database 34. The sale information database 34 is a database in which information on the sale request acquired by the control unit 31 is stored. A sale information table has fields of user ID, area, component ID, first vehicle, selling price, state, and desired date and time. Information for identifying the first user (user ID) is input in a user ID field. An area field stores information on the area where the first user wants to remove the component 100. Information for identifying the component 100 (component ID) that the first user wants to sell and remove is input in a component ID field. Information for identifying the first vehicle 10 is input in a first vehicle field. Examples of information for identifying the first vehicle 10 include a vehicle type and a grade. Information on the selling price of the component 100 desired by the first user is input in a selling price field. Information on the state of the component 100 is input in a state field. In the example illustrated in FIG. 6, the state is specified via five levels from level 1 to level 5. Information on the date and time when the first user wants to remove the component 100 is input in a desired date-and-time field.

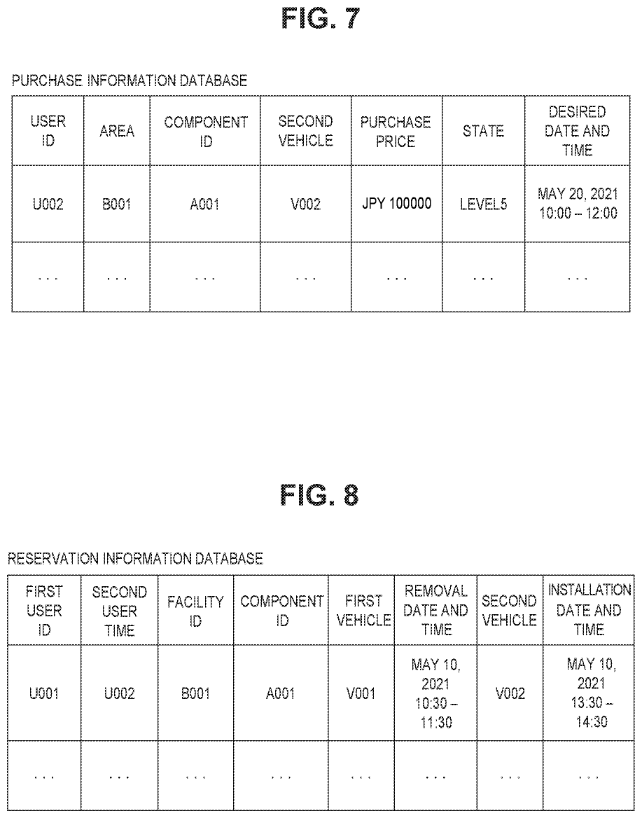

FIG. 7 is a diagram illustrating a table configuration of purchase information stored in the purchase information database 35. The purchase information database 35 is a database in which information on the purchase request acquired by the control unit 31 is stored. A purchase information table has fields of user ID, area, component ID, second vehicle, purchase price, state, and desired date and time. Information for identifying the second user (user ID) is input in a user ID field. An area field stores information on the area where the second user wants to install the component 100. Information for identifying the component 100 (component ID) that the second user wants to purchase and install is input in a component ID field. Information for identifying the second vehicle 20 is input in a second vehicle field. Examples of information for identifying the second vehicle 20 include a vehicle type and a grade. Information on the purchase price of the component 100 desired by the second user is input in a purchase price field. Information on the state of the component 100 desired by the second user is input in a state field. In the example illustrated in FIG. 7, the state is specified via five levels from level 1 to level 5. Information on the date and time when the second user wants to install the component 100 is input in a desired date-and-time field.

FIG. 8 is a diagram illustrating a table configuration of reservation information stored in the reservation information database 36. The reservation information database 36 is a database in which information on the reservation made by the control unit 31 is stored. A reservation information table has fields of first user ID, second user ID, facility ID, component ID, first vehicle, removal date and time, second vehicle, and installation date and time. Information for identifying the first user (user ID) is input in a first user ID field. Information for identifying the second user (user ID) is input in a second user ID field. Information for identifying the facility (facility ID) is input in a facility ID field. Information for identifying the component 100 (component ID) is input in a component ID field. Information for identifying the first vehicle 10 is input in a first vehicle field. Information on the date and time reserved for removing the component 100 from the first vehicle 10 is input in a removal date and time field. Information for identifying the second vehicle 20 is input in a second vehicle field. Information on the date and time reserved for installing the component 100 in the second vehicle 20 is input in an installation date and time field.

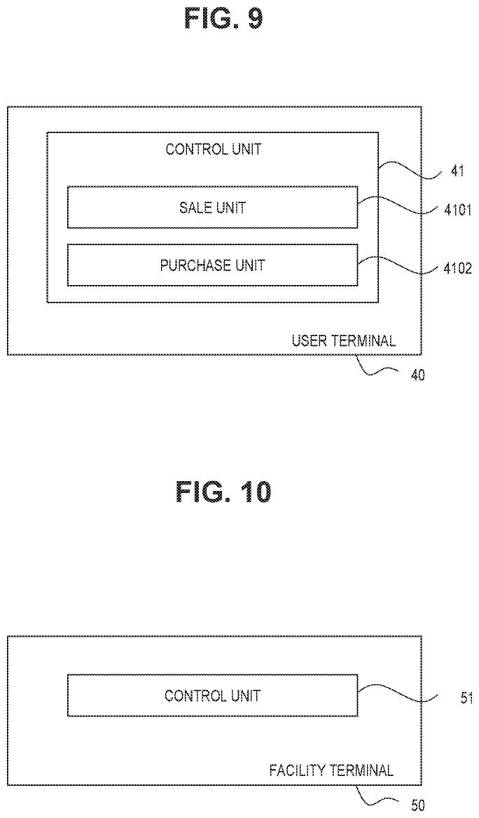

Next, functions of the user terminal 40 will be described. FIG. 9 is a diagram illustrating a functional configuration of the user terminal 40. The user terminal 40 includes a control unit 41 as a functional component. The processor 401 of the user terminal 40 performs the processing of the control unit 41 by a computer program on the primary storage unit 402. The first user terminal 40A and the second user terminal 40B have the same functional configuration. The control unit 41 includes a sale unit 4101 and a purchase unit 4102.

The sale unit 4101 mainly performs a process for selling the component 100. The sale unit 4101 transmits a request for selling and removing the component 100 (sale request) according to the user's input to the input unit 404. The sale unit 4101 causes the display 405 to display a screen for inputting information required for generating the sale request by performing predetermined application software. The sale request includes information that can identify the first user (the user ID), information on the area where the first user wants to remove the component 100, information on the component 100, information on the first vehicle 10, information on the selling price of the component 100, information on the state of the component 100, and information on the date and time when the first user wants to remove the component 100. When the user inputs these pieces of information via the input unit 404, the sale unit 4101 generates the sale request and transmits the sale request to the server 30 via the communication unit 406.

The sale request may be sent to the server 30 via, for example, a website on the Internet. In this case, the sale unit 4101 accesses a predetermined website with a web browser according to the user's input. When accessing the predetermined website, it is requested to input the information that can identify the first user (the user ID), the area where the first user wants to remove the component 100, the component 100, the first vehicle 10, the selling price of the component 100, the state of the component 100, and the desired date and time when the first user wants to remove the component 100. The sale unit 4101 causes the display 405 to display a screen for prompting the input of such information. When the user inputs these pieces of information via the input unit 404, the sale unit 4101 generates the sale request and transmits the sales request to the server 30 via the communication unit 406.

Further, when the sale unit 4101 receives information indicating that the reservation is made from the server 30, the secondary storage unit 403A stores the information on the facility and the information on the removal date and time of the component 100 included in such information. For example, the first user can access the information on the reservation on the display 405A by performing a predetermined operation via the input unit 404A.

The purchase unit 4102 mainly performs a process for purchasing the component 100. The purchase unit 4102 transmits a request for purchasing and installing the component 100 (the purchase request) according to the user's input to the input unit 404. The purchase unit 4102 causes the display 405 to display a screen for inputting information required for generating the purchase request by performing predetermined application software. The purchase request includes information that can identify the second user (the user ID), information on the area where the second user wants to install the component 100, information on the component 100, information on the second vehicle 20, information on the purchase price of the component 100, information on the state of the component 100 that the second user wants to purchase, and information on the date and time when the second user wants to install the component 100. When the user inputs these pieces of information via the input unit 404, the purchase unit 4102 generates the purchase request and transmits the purchase request to the server 30 via the communication unit 406.

The purchase request may be sent to the server 30 via, for example, the website on the Internet. In this case, the purchase unit 4102 accesses the predetermined website with the web browser according to the user's input. When accessing the predetermined website, it is requested to input the information that can identify the second user (user ID), the area where the second user wants to install the component 100, the component 100, the second vehicle 20, the purchase price of the component 100, the state of the component 100 that the second user wants to purchase, and the desired date and time that the second user wants to install the component 100. The purchase unit 4102 causes the display 405 to display a screen for prompting the input of such information. When the user inputs these pieces of information via the input unit 404, the purchase unit 4102 generates the purchase request and transmits the purchase request to the server 30 via the communication unit 406.

Further, when the purchase unit 4102 receives information indicating that the reservation is made from the server 30, the secondary storage unit 403B stores the information on the facility and the information on the installation date and time of the component 100 included in such information. For example, the second user can access the information on the reservation on the display 405B by performing a predetermined operation via the input unit 404B.

Next, functions of the facility terminal 50 will be described. FIG. 10 is a diagram illustrating a functional configuration of the facility terminal 50. The facility terminal 50 includes a control unit 51 as a functional component. The processor 501 of the facility terminal 50 performs the processing of the control unit 51 by a computer program on the primary storage unit 502.

When the worker inputs the facility information, the control unit 51 transmits the facility information to the server 30. The facility information includes information on the component ID of the component 100 that the facility can deal with, the facility ID, and the date and time when reservation is available (date and time when no reservation is made). The facility information may be input, for example, to the website on the Internet. In this case, the control unit 51 accesses a predetermined website with the web browser according to the worker's input. When accessing the predetermined website, it is requested to input the facility ID, the component 100, and the possible reservation date and time. The control unit 51 causes the display 505 to display a screen for prompting the input of such information. When the worker inputs these pieces of information via the input unit 504, the control unit 51 transmits the information to the server 30 via the communication unit 506.

Further, when the control unit 51 receives information indicating that the reservation is made from the server 30, the secondary storage unit 503 stores the information on the first user, the information on the second user, the information on the component 100, the information on the first vehicle 10, the information on the removal date and time, the information on the second vehicle 20, and the information on the installation date and time, which are included in such information. For example, the worker can access the information indicating that the reservation is completed on the display 505 by performing a predetermined operation via the input unit 504.

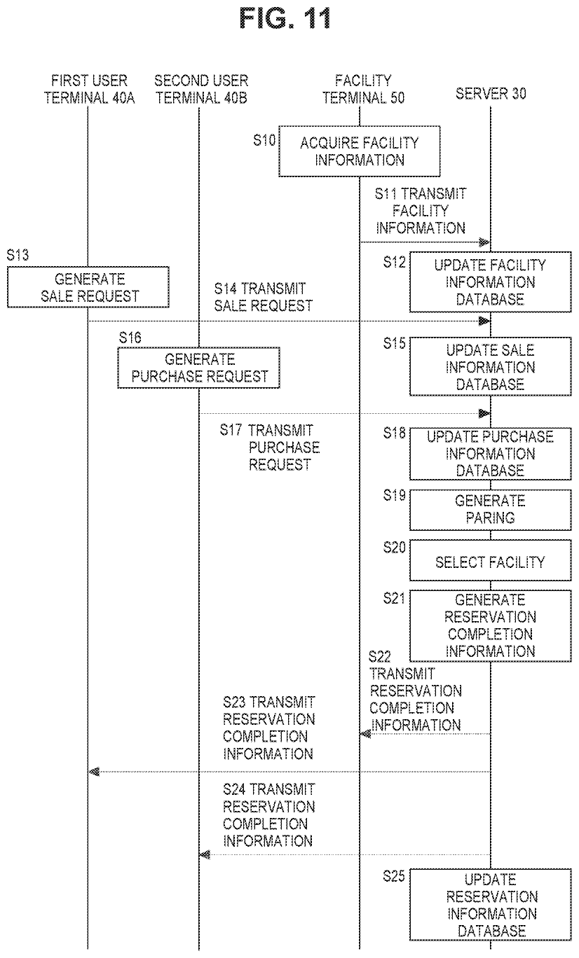

Next, entire processing of the system 1 will be described. FIG. 11 is a sequence diagram illustrating the entire processing of the system 1. It is assumed that the component information is already stored in the component information database 32. In FIG. 11, when the worker inputs facility information (facility ID, component ID, location, and possible reservation date and time) to the facility terminal 50, the facility terminal 50 acquires the facility information (S10). The facility terminal 50 transmits the facility information to the server 30 (S11). The server 30 that has acquired the facility information updates the facility information database 33 according to the facility information (S12). In FIG. 11, the facility terminal 50 first transmits the facility information to the server 30, but the facility information may be appropriately transmitted at any time.

Next, the first user inputs the information related to the sale request to the first user terminal 40A. The first user terminal 40A generates the sale request (S13). The sale request generated by the first user terminal 40A is transmitted to the server 30 (S14). The server 30 that has received the sale request stores the information included in the sale request in the sale information database 34 (S15). The second user inputs the information related to the purchase request to the second user terminal 40B. The second user terminal 40B generates the purchase request (S16). The purchase request generated by the second user terminal 40B is transmitted to the server 30 (S17). The server 30 that has received the purchase request stores the information included in the purchase request in the purchase information database 35 (S18).

The server 30 generates a paring of the first vehicle 10 and the second vehicle 20 based on the information stored in the sale information database 34 and the purchase information database 35 (S19). The server 30 generates a paring of the first vehicle 10 and the second vehicle 20 such that the area, the component ID, the selling price and the state, which are stored in the sale information database 34, match the area, the component ID, the purchase price and the state, which are stored in the purchase information database 35, and the desired date and time stored in the sale information database 34 are earlier than the desired date and time stored in the purchase information database 35.

Further, the server 30 selects the facility corresponding to the generated paring of the first vehicle 10 and the second vehicle 20 based on the information stored in the component information database 32 and the facility information database 33 (S20). The server 30 may extract, for example, the installation time and the removal time corresponding to the component 100 from the component information database 32. These times are compared with the possible reservation date and time stored in the facility information database 33 to extract facility candidates each having an available time when the component 100 can be removed and installed. The facility located at the area desired by the first user and the second user is selected from among the facility candidates.

When the facility is selected, the server 30 generates reservation completion information (S21). The reservation completion information includes information for notifying the user terminal 40 that the reservation is completed and information for notifying the facility terminal 50 that the reservation is completed. The information on the first user ID, the information on the second user, the information on the component 100, the information on the first vehicle 10, the information on the removal date and time, the information on the second vehicle 20, and the information on the installation date and time are transmitted to the facility terminal 50 (S22). The information on the facility and the information on the removal date and time are transmitted to the first user terminal 40A (S23). The information on the facility and the information on the installation date and time are transmitted to the second user terminal 40B (S24).

The server 30 updates the reservation information database 36 by storing the reservation information (information on the user ID, information on the facility ID, information on the component ID, information on the first vehicle 10, information on the removal date and time, information on the second vehicle 20, and information on the installation date and time) in the reservation information database 36 (S25).

In the example illustrated in FIG. 11, the reservation is completed immediately after the server 30 generates the paring based on the sale information and the purchase information in S19. However, alternatively, the reservation may be completed in a case where the first user and the second user are asked to confirm the paring and accept a deal. For example, information on the attributes (for example, age and gender) of the first user, image data of the component 100, the date and time when the component 100 is installed in the second vehicle 20, or information on the facility (for example, work history, reputation, or location) is transmitted to the second user terminal 40B. When the second user confirms and accepts a deal, a notification is transmitted from the second user terminal 40B to the server 30. Similarly, the date and time when the component 100 is removed from the first vehicle 10 or information about the facility (for example, work history, word of mouth, or location) is transmitted to the first user terminal 40A. When the first user confirms and accepts a deal, a notification is transmitted from the first user terminal 40A to the server 30. The reservation completion information may be generated to complete the reservation only in a case where consent is obtained from both users.

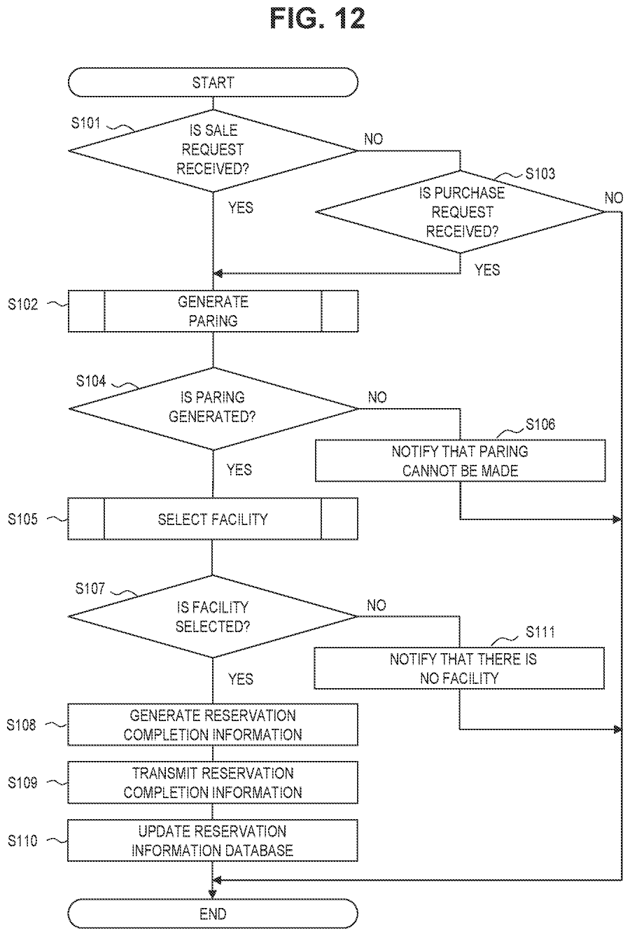

Next, processing performed in the server 30 will be described. FIG. 12 is a flowchart of a reservation process in the server 30 according to a first embodiment. The reservation process illustrated in FIG. 12 is repeatedly performed on the server 30 at predetermined time intervals. It is assumed that the facility information (information on the facility ID, information on the component ID, information on the location, and information on the possible reservation date and time) is received from the facility terminal 50 at any time. Further, it is assumed that the user and the facility are registered in the server 30 in advance.

In step S101, the control unit 31 determines whether the sale request has been received from the user terminal 40. For example, in a case where a new input is introduced into the sale information database 34, the control unit 31 may determine that the sale request has been received. In step S101, when a positive determination is made, the processing proceeds to step S102. On the other hand, when a negative determination is made, the processing proceeds to step S103. In step S103, the control unit 31 determines whether the purchase request has been received from the user terminal 40. For example, in a case where a new input is introduced into the purchase information database 35, the control unit 31 may determine that the purchase request has been received. In step S103, when a positive determination is made, the processing proceeds to step S102. On the other hand, when a negative determination is made, this routine ends. In step S101 and step S103, the control unit 31 determines whether at least one of the sale request and the purchase request has been received.

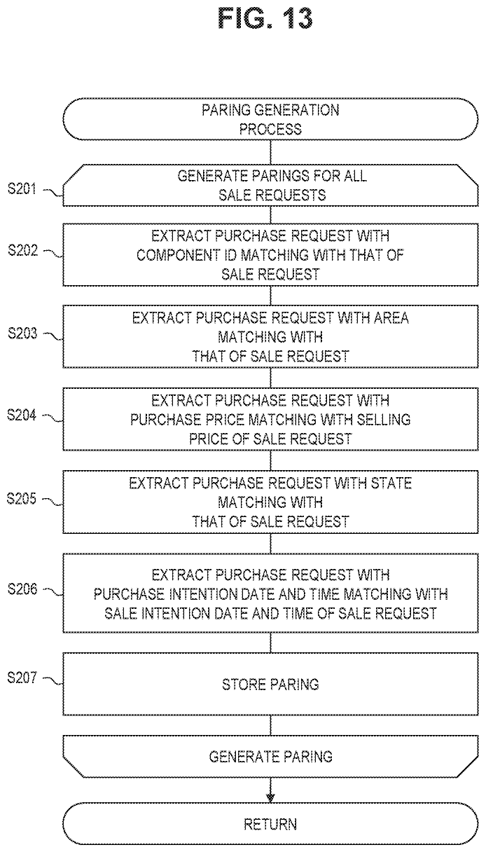

The control unit 31 generates the paring of the first vehicle 10, the second vehicle 20, and the facility in step S102. FIG. 13 is a flowchart illustrating a flow of a paring generation process executed in step S102. In step S201, the control unit 31 starts to repeatedly generate the paring of the first vehicle 10 and the second vehicle 20 for all the sale requests.

In step S202, the control unit 31 extracts purchase requests in which the component ID related to the sale request match the component ID related to the purchase request. In step S203, the control unit 31 extracts purchase requests in which the area related to the sale request matches the area related to the purchase request, from among the purchase requests extracted in step S202. In step S204, the control unit 31 extracts purchase requests in which the selling price related to the sale request matches the purchase price related to the purchase request, from among the purchase requests extracted in step S203. In step S205, the control unit 31 extracts purchase requests in which the state related to the sale request matches the state related to the purchase request, from among the purchase requests extracted in step S204. Purchase requests may be extracted in which the state related to the sale request is better than the state related to the purchase request.

In step S206, the control unit 31 extracts a purchase request in which the date and time when the first user wants to sell the component (a sale intention date) in association with the sale request are earlier than the date and time when the second user wants to purchase the component (a purchase intention date) in association with the purchase request, from among the purchase requests extracted in step S205. In step S207, the control unit 31 stores a paring of the first vehicle 10 related to the sale request and the second vehicle 20 related to the purchase request extracted in step S206 in the secondary storage unit 303. A plurality of parings may be stored. Accordingly, the sale request and the purchase request are compared in a round-robin manner to generate a paring which satisfies the conditions.

Returning to FIG. 12, in step S104, the control unit 31 determines whether the paring has been generated in step S102. In step S104, when a positive determination is made, the processing proceeds to step S105. On the other hand, when a negative determination is made, the processing proceeds to step S106. In step S106, the control unit 31 transmits to the user terminal 40 a notification indicating that a paring cannot be made. This paring is a notification indicating that the first vehicle 10 or second vehicle 20 satisfying the conditions cannot be found. This user terminal 40 is the user terminal that has transmitted the sale request of which receipt has been determined in step S101 or the purchase request of which receipt has been determined in step S103. As stated above, in a case where the component 100 which satisfies the conditions cannot be found, the user is only registered in the server 30 and waits until the component 100 which satisfies the conditions is found.

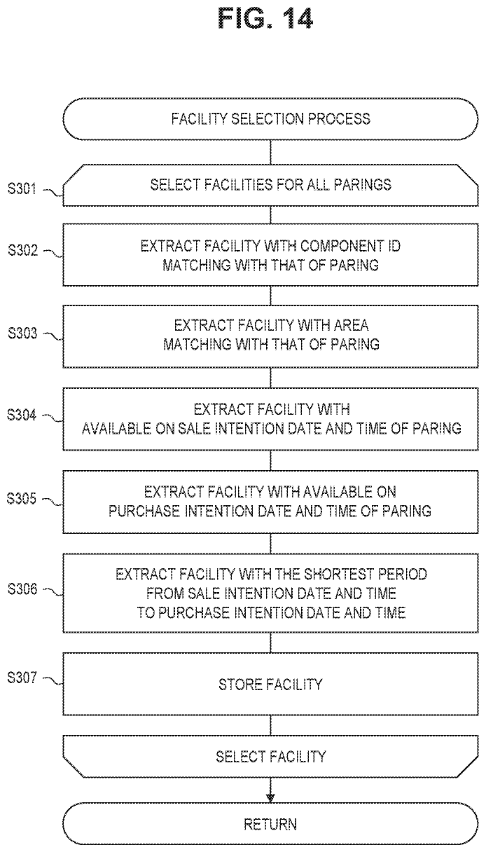

In step S105, the control unit 31 selects the facility. FIG. 14 is a flowchart illustrating a flow of a facility selection process performed in step S105. In step S301, the control unit 31 starts to repeatedly select the facility for all parings generated in step S102.

In step S302, the control unit 31 extracts facilities in which the component ID related to the paring matches the component ID related to the facility. In step S303, the control unit 31 extracts facilities in which the area related to the paring matches the area related to the facility, from among the facilities extracted in step S302. In step S304, the control unit 31 extracts facilities in which the facilities have an available time on the sale intention date and time related to the paring, from among the facilities extracted in step S303. In step S305, the control unit 31 extracts facilities in which the facilities have an available time on the purchase intention date and time related to the paring, from among the facilities extracted in step S304.

In step S306, the control unit 31 extracts a facility in which a time period between the sale intention date and time to the purchase intention date and time is the shortest, from among the facilities extracted in step S305. For example, the component 100 is stored in the facility during a period from the time when the component 100 is removed from the first vehicle 10 to the time when the component 100 is installed in the second vehicle 20. Therefore, the shorter the time period when the component 100 is removed from the first vehicle 10 to the time when the component 100 is installed in the second vehicle 20, the shorter a period for storing the component 100 in the facility. In step S306, the control unit 31 extracts a facility in which a time period between the sale intention date and time to the purchase intention date and time is the shortest, from among the facilities extracted in step S305, such that a time period for storing the component 100 is the shortest.

In step S307, the control unit 31 stores a paring of the first vehicle 10 and the second vehicle 20, and the facility extracted in S306 in the secondary storage unit 303. The paring of the first vehicle 10 and the second vehicle 20, and the facility are compared in a round-robin manner to select a facility which satisfies the conditions.

Returning to FIG. 12, in step S107, the control unit 31 determines whether the facility has been selected in step S105. In step S107, when a positive determination is made, the processing proceeds to step S108. On the other hand, when a negative determination is made, the processing proceeds to step S111. In step S111, the control unit 31 transmits, to the user terminal 40, a notification indicating that there is no facility. This notification is a notification indicating that the facility which satisfies the conditions cannot be found. This user terminal 40 is the user terminal that has transmitted the sale request of which receipt has been determined in step S101 or the purchase request of which receipt has been determined in step S103. As stated above, in a case where the facility which satisfies the conditions cannot be found, the user is only registered in the server 30 and waits until the facility which satisfies the conditions is found.

In step S108, the control unit 31 generates the reservation completion information. The reservation completion information is information for notifying the worker that the reservation is made and information for notifying the user that the reservation is completed. The reservation completion information transmitted to the facility terminal 50 includes the information on the first user ID, the information on the second user ID, the information on the component 100, the information on the first vehicle 10, the information on the removal date and time, the information on the second vehicle 20, and the information on the installation date and time. The reservation completion information transmitted to the first user terminal 40A includes the information on the facility and the information on the date and time when the component 100 is removed. The reservation completion information transmitted to the second user terminal 40B includes the information on the facility and the information on the date and time when the component 100 is installed.

In step S109, the control unit 31 transmits the reservation completion information to the user terminal 40 and the facility terminal 50. In step S110, the control unit 31 updates the reservation information database 36. That is, the reservation information database 36 stores the information on the first user ID, the information on the second user ID, the information on the facility ID, the information on the component ID, the information on the first vehicle 10, the information on the removal date and time, the information on the second vehicle 20, and the information on the installation date and time.

As stated above, with the first embodiment, the server 30 reserves the facility in a case where the first user wants to sell and remove the component 100 from the first vehicle 10, and the second user wants to purchase and install the component 100 in the second vehicle 20. When the first vehicle 10 and the second vehicle 20 are brought into the facility according to this reservation, the component 100 can be moved. The first user can make a profit by selling the component 100. The second user can get a component 100 that is difficult to obtain. Even when the component 100 is difficult for the user to replace, the facility can deal with the component 100. It is possible to effectively utilize second-hand parts.

In the process illustrated in FIG. 12, in a case where the facility is selected based on the sale request and the purchase request, the reservation is immediately confirmed. Alternatively, information for confirming whether the reservation is acceptable may be transmitted to the first user terminal 40A, the second user terminal 40B, or the facility terminal 50. The facility may be reserved only in a case where the first user terminal 40A, the second user terminal 40B, or the facility terminal 50 confirms that the reservation is acceptable.

In the process illustrated in FIG. 12, a plurality of parings are generated in step S102, and the facility at which the component 100 will be stored for the shortest time period is selected in step S105. Alternatively, a paring of the first vehicle 10 and the second vehicle 20, in which a time period from the sale intention date and time to the purchase intention date and time is the shortest, may be generated in step S102, and the facility that can deal with such a paring may be selected in step S105. In this case, in a case where the facility that can deal with the paring cannot be found, a paring in which a time period from the sale intention date and time to the purchase intention date and time is the second shortest may be generated, and the facility that can deal with such a paring may be selected in step S105. This process may be repeatedly performed to generate the paring of the first vehicle 10 and the second vehicle 20 until the facility which satisfies the conditions is found.

### Second Embodiment

In the first embodiment, the server 30 determines the removal date and time and the installation date and time of the component 100. On the other hand, in the second embodiment, the user can select the removal date and time or the installation date and time of the component 100 from a plurality of candidates. The user may be able to select the facility that they wish to use from a plurality of facilities at that time. Further, for example, the second user may select the component 100 to be installed in the second vehicle 20 from a plurality of components 100 based on the state of the component 100. Further, for example, in a case where the selling price for the component 100 differs depending on the first user, the server 30 may present the selling price of each first user to the second user. Further, for example, in a case where the removal date and time of removing the component 100 from the first vehicle 10 is known, the server 30 may present the removal date and time to the second user. Further, in a case where the fee or storage fee of the component 100 differs depending on the facility, the server 30 may present the charges of each facility to the second user. This configuration can improve the user's convenience.

When the control unit 31 of the server 30 receives, for example, the sale request from the first user terminal 40A, the control unit 31 generates a list of facilities that can deal with the sale request (hereinafter, also referred to as a “facility list”). The facility list is information through which the first user selects the facility. In the second embodiment, it is not necessary to include the desired date and time in the sale request because the first user later selects the date and time for removing the component 100. Further, the information on the state of the component 100 included in the sale request may contain data obtained by capturing images of the component 100.

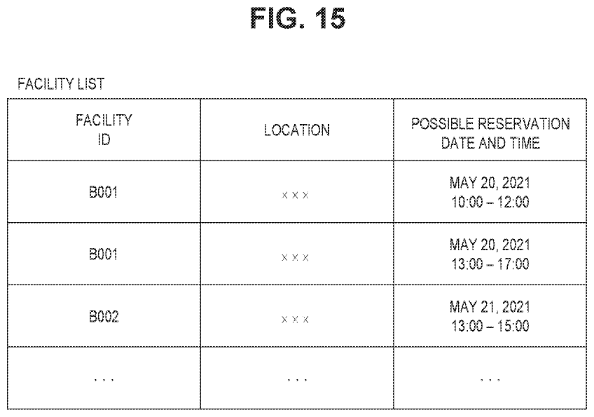

FIG. 15 is a diagram illustrating one example of the facility list. The facility list contains the information on the facility ID, the information on the facility location, and the information on the possible reservation date and time. This facility list is data obtained by extracting the facilities that can deal with the component 100 included in the sale request from the facility information database 33. The facility list is transmitted from the server 30 to the first user terminal 40A, and an image corresponding to the facility list is displayed on the display 405A of the first user terminal 40A. The facility list may present several possible reservation date and times corresponding to the same facility.

The first user selects the facility and the possible reservation date and time, at which they want to remove the component 100, from the facility list. At this time, for example, the first user taps the facility ID displayed on the display 405A to select the facility and the possible reservation date and time. When the first user selects the facility and the possible reservation date and time, the information on the selected facility and the possible reservation date and time is transmitted from the first user terminal 40A to the server 30. The control unit 31 of the server 30 updates the reservation information database 36 illustrated in FIG. 8 by storing the facility and the possible reservation date and time, selected by the first user, in the reservation information database 36. The information on the second user ID is not input at this time.

When the control unit 31 of the server 30 receives, for example, the purchase request from the second user terminal 40B, the control unit 31 generates a sale list of the component 100 corresponding to the purchase request. The sale list is information through which the second user selects the component.

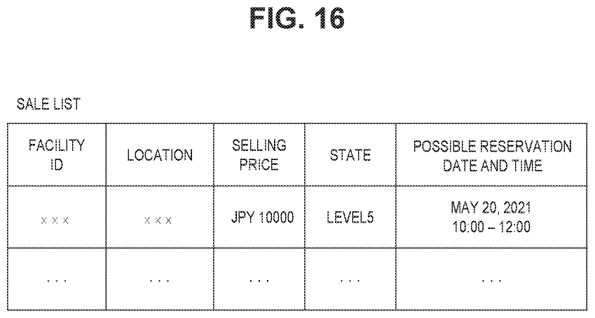

FIG. 16 is a diagram illustrating one example of the sale list. The sale list contains the information on the facility ID, the information on the location of the facility, the information on the selling price of the component, the information on the state of the component, and the information on the possible reservation date and time for installing the component in the second vehicle 20. This sale list is data generated based on a record which satisfies the conditions of the purchase request, from among records in which the second user ID is not input in the reservation information database 36. When generating the sale list, the control unit 31 refers to the facility information database 33, the sale information database 34, the purchase information database 35, and the reservation information database 36. The sale list presents several possible reservation date and times corresponding to the same facility.

The components 100 listed on the sale list include, for example, the component 100 that has already been removed from the first vehicle 10 and is stored in the facility, and the component 100 that is scheduled to be removed from the first vehicle 10. The facility ID included in the list corresponds to the facility in which the component 100 is removed and stored. The sale list is transmitted from the server 30 to the second user terminal 40B, and an image corresponding to the sale list is displayed on the display 405B of the second user terminal 40B. Image data can also be used as the information on the state of the component 100.

The second user selects the facility and the possible reservation date and time, at which they want to install the component 100, from the sale list. At this time, for example, the first user taps the facility ID displayed on the display 405B to select the facility and the possible reservation date and time. When the second user selects the facility and the possible reservation date and time, the information on the selected facility and the possible reservation date and time is transmitted from the second user terminal 40B to the server 30. The control unit 31 of the server 30 updates the reservation information database 36 by storing the facility and the possible reservation date and time, selected by the second user, in a corresponding space of the reservation information database 36.

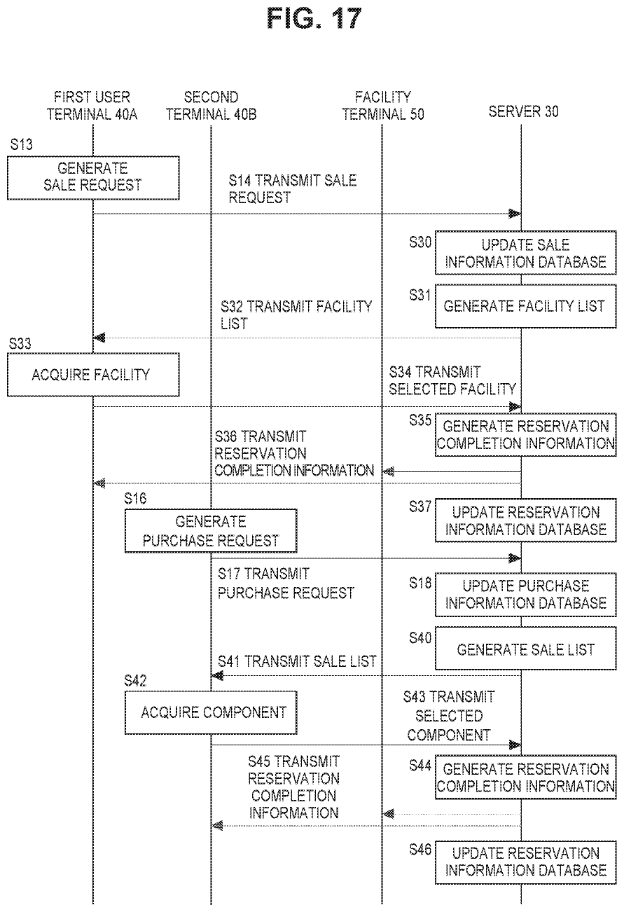

Next, entire processing of the system 1 will be described. FIG. 17 is a sequence diagram illustrating the entire processing of the system 1. It is assumed that the component information is already stored in the component information database 32. The processes up to S14 are the same as those illustrated in FIG. 11, and thus descriptions and a part of illustrations thereof will be omitted. Upon receiving the sale request, the server 30 updates the sale information database 34 by inputting information in each field of the sale information database 34 (S30). Next, the server 30 generates the facility list (S31). The server 30 transmits the generated facility list to the first user terminal 40A (S32).

The information on the facility list is displayed on the display 405A of the first user terminal 40A. When the first user selects the facility and the possible reservation time via the input unit 404A, the first user terminal 40A acquires information on the facility and the selected possible reservation time (S33). The information on the facility and the selected possible reservation time is transmitted from the first user terminal 40A to the server 30 (S34).

The server 30 that has received the information on the facility and the possible reservation time selected from the first user terminal 40A generates the reservation completion information (S35). The reservation completion information includes information for notifying the first user terminal 40A that the reservation is completed and information for notifying the facility terminal 50 that the reservation for the first user is completed. The information on the first user, the information on the component 100, the information on the first vehicle 10, and the information on the removal date and time are transmitted to the facility terminal 50. The information on the facility and the information on the removal date and time are transmitted to the first user terminal 40A (S36).

The server 30 updates the reservation information database 36 by storing the information on the first user ID, the information on the facility ID, the information on the component ID, the information on the first vehicle 10, and the information on the removal date and time in the reservation information database 36 (S37). At this time, the corresponding second user ID field, the second vehicle field, and the installation date and time field remain blank.

When the server 30 receives the purchase request from the second user terminal 40B (S17) and updates the purchase information database 35 (S18), the server 30 generates the sale list (S40). The server 30 transmits the generated sale list to the second user terminal 40B (S41). The information on the sale list is displayed on the display 405B of the second user terminal 40B. When the second user selects the facility and the possible reservation time from the sale list via the input unit 404B, the second user terminal 40B acquires information on the selected facility and the selected possible reservation time (S42). The information on the selected facility and the selected possible reservation time is transmitted from the second user terminal 40B to the server 30 (S43).

The server 30 that has received the information on the selected facility and the selected possible reservation time from the second user terminal 40B generates the reservation completion information (S44). The reservation completion information includes information for notifying the second user terminal 40B that the reservation is completed and information for notifying the facility terminal 50 that the reservation for the second user is completed. The information on the first user, the information on the second user, the information on the component 100, the information on the first vehicle 10, the information on the removal date and time, the information on the second vehicle 20, and the information on the installation date and time are transmitted to the facility terminal 50. The information on the facility and the information on the installation date and time are transmitted to the second user terminal 40B (S45).

The server 30 updates the reservation information database 36 by storing the information on the second user ID, the information on the second vehicle 20, and the information on the installation date and time in the respective fields of the reservation information database 36, which have remained blank in S37 (S46).

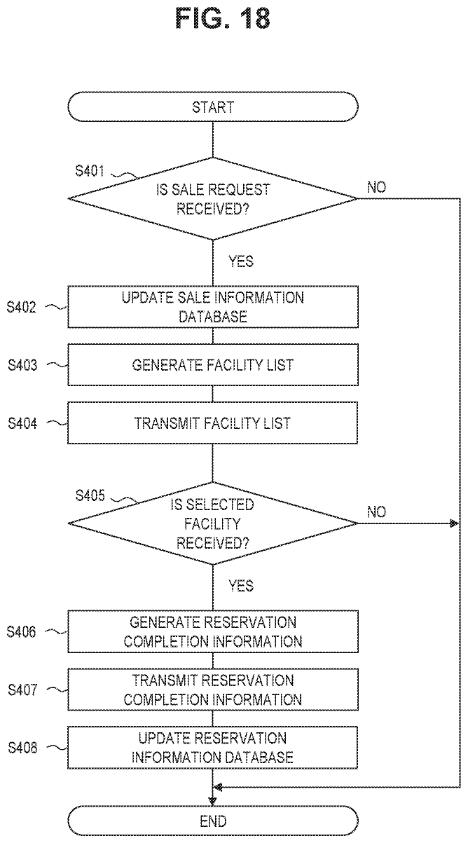

Next, processing executed when the server 30 receives the sale request will be described. FIG. 18 is a flowchart of a process when the server 30 according to the second embodiment receives the sale request. The process illustrated in FIG. 18 is repeatedly executed on the server 30 at predetermined time intervals. It is assumed that the facility information (information on the facility ID, information on the component ID, information on the location, and information on the possible reservation date and time) is received from the facility terminal 50 at any time. Further, it is assumed that the user and the facility are registered in the server 30 in advance.

In step S401, the control unit 31 determines whether the sale request has been received from the first user terminal 40A. In step S401, when a positive determination is made, the processing proceeds to step S402. On the other hand, when a negative determination is made, this routine ends. In step S402, the control unit 31 updates the sale information database 34. In other words, the server 30 updates the sale information database 34 by inputting information in each field of the sale information database 34 as illustrated in FIG. 6.

In step S403, the control unit 31 generates the facility list. The control unit 31 compares the component ID included in the sale request received in step S401 with the component ID corresponding to each facility stored in the facility information database 33, and extracts facilities in which those component IDs match. The facilities included in the facility list may be limited based on the information on the area included in the sale request. For example, the facility candidates may be limited to those in the area included in the sale request or those within a predetermined distance of such an area. In a case where the sale request includes the desired date and time, the facility candidates may be limited to those that have an available time without reservation on the desired date and time. The facility list illustrated in FIG. 15 is generated based on the facility IDs, the locations, and the possible reservation date and times, corresponding to the extracted facilities. In step S404, the control unit 31 transmits the generated facility list to the first user terminal 40A. The information on the facility list is displayed on the display 405A of the first user terminal 40A.

In step S405, the control unit 31 determines whether information on the selected facility has been received from the first user terminal 40A. The information on the selected facility includes information on the facility ID of the facility selected by the first user and the sale intention date and time (the possible reservation date and time). In a case where the information on the selected facility is not received from the first user terminal 40A even after waiting for a predetermined time, or in a case where information indicating that the first user does not want to select such a facility is received, it is determined that the information on the selected facility is not received. In step S405, when a positive determination is made, the processing proceeds to step S406. On the other hand, when a negative determination is made, this routine ends.

In step S406, the control unit 31 generates the reservation completion information. The reservation completion information herein is information for notifying the worker that the reservation is made and information for notifying the first user that the reservation is completed. The reservation completion information transmitted to the facility terminal 50 includes the information on the first user, the information on the component 100, the information on the first vehicle 10, and the information on the removal date and time. The reservation completion information transmitted to the first user terminal 40A includes the information on the facility and the information on the date and time when the component 100 is removed.

In step S407, the control unit 31 transmits the reservation completion information to the first user terminal 40A and the facility terminal 50. In step S408, the control unit 31 updates the reservation information database 36. That is, the reservation information database 36 stores the information on the first user ID, the information on the facility ID, the information on the component ID, the information on the first vehicle 10, and the information on the removal date and time.

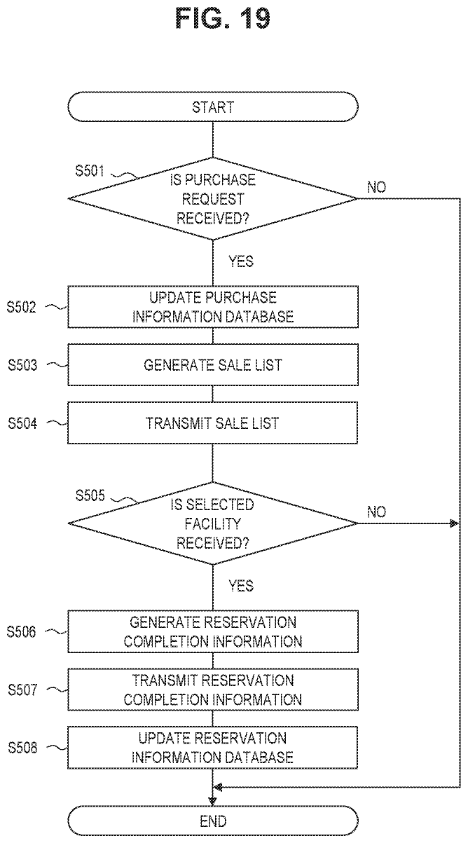

Next, processing executed when the server 30 receives the purchase request will be described. FIG. 19 is a flowchart of a process when the server 30 according to the second embodiment receives the purchase request. The process illustrated in FIG. 19 is repeatedly executed on the server 30 at predetermined time intervals. It is assumed that the facility information (information on the facility ID, information on the component ID, information on the location, and information on the possible reservation date and time) is received from the facility terminal 50 at any time. Further, it is assumed that the user and the facility are registered in the server 30 in advance. A routine illustrated in FIG. 19 can be performed independently of the routine illustrated in FIG. 18.

In step S501, the control unit 31 determines whether the purchase request has been received from the second user terminal 40B. In step S501, when a positive determination is made, the processing proceeds to step S502. On the other hand, when a negative determination is made, this routine ends. In step S502, the control unit 31 updates the purchase information database 35. In other words, the server 30 updates the purchase information database 35 by inputting information in each field of the purchase information database 35 as illustrated in FIG. 7.

In step S503, the control unit 31 generates the sale list. The control unit 31 compares the component ID included in the purchase request received in step S501 with the component IDs stored in the reservation information database 36, and extracts facilities in which those component IDs match. At this time, the control unit 31 extracts a record in which the second user ID is not input. The components 100 included in the sale list may be limited based on the information on the area included in the purchase request. For example, the candidates for the component 100 may be limited to those removed in the area included in the purchase request or those within a predetermined distance from such an area. In a case where the purchase request includes the desired date and time, the candidates for the component 100 may be limited to those removed at facilities that have an available time without reservation on the desired date and time.

Further, the control unit 31 extracts the selling price and the state of the component 100 from the user ID and the component ID corresponding to the extracted record, and the information stored in the sale information database 34. Moreover, the control unit 31 extracts the location of the facility and the possible reservation date and time for installing the component 100 from the facility ID corresponding to the extracted record, and the information stored in the facility information database 34. The control unit 31 generates the sale list illustrated in FIG. 16 based on the facility ID, the location of the facility, the selling price of the component 100, the state of the component 100, and the possible reservation date and time.

In step S504, the control unit 31 transmits the generated sale list to the second user terminal 40B. The information on the sale list is displayed on the display 405B of the second user terminal 40B.

In step S505, the control unit 31 determines whether information on the selected facility has been received from the second user terminal 40B. The information on the selected facility includes information on the facility ID of the facility selected by the second user and the purchase intention date and time (the possible reservation date and time). In a case where the information on the selected facility is not received from the second user terminal 40B even after waiting for a predetermined time, or in a case where information indicating that the second user does not want to select such a facility is received, it is determined that the information on the selected facility is not received. In step S505, when a positive determination is made, the processing proceeds to step S506. On the other hand, when a negative determination is made, this routine ends.

In step S506, the control unit 31 generates the reservation completion information. The reservation completion information herein is information for notifying the worker that the reservation is made and information for notifying the second user that the reservation is completed. The reservation completion information transmitted to the facility terminal 50 includes the information on the first user, the information on the second user, the information on the component 100, the information on the first vehicle 10, the information on the removal date and time, the information on the second vehicle 20, and the information on the installation date and time. The reservation completion information transmitted to the second user terminal 40B includes the information on the facility and the information on the date and time when the component 100 is installed.

In step S507, the control unit 31 transmits the reservation completion information to the second user terminal 40B and the facility terminal 50. In step S508, the control unit 31 updates the reservation information database 36. That is, the control unit 31 stores the information on the second user ID, the information on the second vehicle 20, and the information on the installation date and time in a corresponding record of the reservation information database 36.

As stated above, according to the second embodiment, the server 30 reserves the facility in a case where the first user desires to sell and remove the component 100 from the first vehicle 10, and the second user wants to purchase and install the component 100 in the second vehicle 20. The first user can select the facility to remove the component 100 from the first vehicle 10 and the date and time when the component 100 is removed. Further, the second user can select the component 100 to be installed in the second vehicle 20, the facility to install the component 100, and the date and time when the component 100 is installed. Therefore, the user can select from a variety of candidates, and it is possible to more effectively utilize second-hand parts.

### Third Embodiment

In a third embodiment, the second user is charged the storage fee for storing the component 100 in the facility during a period from the time when the component 100 is removed from the first vehicle 10 to the time when the component 100 is installed in the second vehicle 20. The component 100 may be stored in, for example, the facility during the period from the time when the component 100 is removed from the first vehicle 10 to the time when the component 100 is installed in the second vehicle 20. In this case, for example, the facility may need to prepare a place used for storing the component 100. Moreover, workers need to manage the component 100. Those costs will be charged to the second user. For example, the longer the component 100 is stored, the higher the storage fee will be. In this case, the second user is charged a basic charge plus the storage fee according to a storage time. Alternatively, the shorter the component 100 is stored, the lower the storage fee may be. In this case, the shorter the storage time is, the more the basic charge may be discounted. Alternatively, the shorter the component 100 is stored, the greater rewards are given to the second user. The rewards may be, for example, coupons that can be used at the facility.

The storage fee may be set according to, for example, the number of days or the time. In a case where the component 100 is removed and installed within a predetermined number of days or within a predetermined time, the storage fee may not be charged.

The sale list of FIG. 16 illustrated in the second embodiment may include information on the storage fee. That is, for each component 100 in the sale list, the storage fee may be calculated based on the date and time when the component 100 is sold, and the possible reservation date and time, and may be displayed on the sale list. For example, when the facility list is generated in step S403 of FIG. 18, a period from the end of the date and time when the first vehicle 10 makes a reservation to the start of the possible reservation date and time of the facility is calculated, and the storage fee is charged according to the period. The storage fee is included in the sale list and transmitted to the second user terminal 40B. The second user can select the component 100 based on the total sum of the selling price and the storage fee.

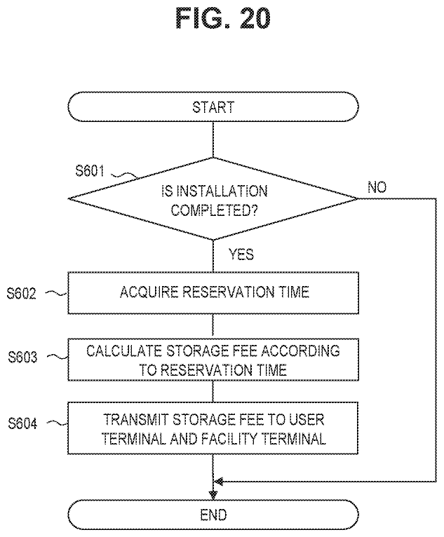

Next, processing performed in the server 30 will be described. FIG. 20 is a flowchart of a process performed in the server 30 according to the third embodiment. The process illustrated in FIG. 20 is repeatedly performed on the server 30 at predetermined time intervals.

In step S601, the control unit 31 determines whether the component 100 has been completely installed in the second vehicle 20. The control unit 31 may determine that the component 100 has been completely installed by, for example, acquiring information indicating that the work has been completed from the facility terminal 50. For example, in a case where the reservation time for installing the component 100 in the second vehicle 20 has passed, it may be determined that the component 100 has been completely installed. In step S601, when a positive determination is made, the processing proceeds to step S602. On the other hand, when a negative determination is made, this routine ends.

In step S602, the control unit 31 acquires a reservation time. The control unit 31 acquires the reservation time for each of the first vehicle 10 and the second vehicle 20 to calculate the storage time of the component 100. In step S603, the control unit 31 calculates the storage fee according to the reservation time. The control unit 31 calculates, as the storage time, a time period from the end of the reservation time for removing the component 100 from the first vehicle 10 to the start of the reservation time for installing the component 100 in the second vehicle 20, and further calculates the storage fee according to the storage time. A relationship between the storage time and the storage fee is stored in the secondary storage unit 303 in advance. For example, the longer the storage time gets, the higher the storage fee is. The control unit 31 generates information on the storage fee according to the calculated storage fee.

In step S604, the control unit 31 transmits the information on the storage fee to the second user terminal 40B and the facility terminal 50. The second user terminal 40B and the facility terminal 50 that have received this information notify the second user and the worker of the storage fee by displaying the storage fee on the display 405B and the display 505. At this time, information on the fee for the installation of the component 100 may also be transmitted to the second user terminal 40B and the facility terminal 50.

The second user pays the purchase price of the component 100, the fee for the installation of the component 100 and the storage fee for the retainment of the component 100. This payment may be, for example, made online or paid at the facility after the component 100 has been installed in the second vehicle 20. Further, the server 30 may remit the purchase price of the component 100 paid by the second user to the first user. Further, the first user may receive the purchase price of the component 100 after the component 100 has been installed in the second vehicle 20, or may receive it from the facility when the component 100 is removed from the first vehicle 10.

As stated above, with the third embodiment, it is possible to promote the second user to advance the reservation time by charging the second user with the storage fee according to the storage time of the component 100. Consequently, it is possible to prevent a storage space from having no availability. Moreover, the facility can receive compensation for storing the component 100.

### Other Embodiments

The embodiments stated above are mere examples, and the present disclosure can be implemented with appropriate modifications without departing from the scope thereof.

The processing and units described in the present disclosure can be freely combined and implemented within a range in which no technical contradiction arises.

Further, the processing described as being performed by a single device may be performed in a shared manner by a plurality of devices. Alternatively, the process described as being performed by different devices may be performed by a single device. In the computer system, the hardware configuration (a server configuration) used for implementing each function can be flexibly changed. For example, the facility terminal 50 may have a part or all of the functions of the server 30.

The present disclosure can also be implemented by supplying a computer program for executing the functions described in the embodiments in a computer, and reading and performing the program by one or more processors included in the computer. Such a computer program may be provided to the computer by a non-transitory computer-readable storage medium connectable to a computer system bus, or may be provided to the computer via the network. Examples of the non-transitory computer-readable storage medium include a random disk (such as a magnetic disk (a Floppy® disk, and an HDD) or an optical disc (such as a CD-ROM, a DVD, and a Blu-ray disc)), a ROM, a RAM, an EPROM, an EEPROM, a magnetic card, a flash memory, an optical card, and a random type of medium suitable for storing electronic instructions.

What is claimed is:

1. An information processing device comprising:
a control unit configured to:
acquire a request from a first user to move a component included in a first vehicle from the first vehicle; and
determine, in response to a request from a second user to move the component to a second vehicle, a possible reservation time of a predetermined facility at which the component is to be moved based on the request from the first vehicle.

2. The information processing device according to claim 1, wherein the control unit is configured to generate a paring of the first vehicle and the second vehicle.

3. The information processing device according to claim 1, wherein the control unit is configured to:
generate information on a first reservation for reserving the predetermined facility at which the component is moved from the first vehicle; and
generate information on a second reservation for reserving the predetermined facility at which the component is moved to the second vehicle.

4. The information processing device according to claim 3, wherein the control unit is configured to generate the information on the first reservation and the information on the second reservation such that the first reservation is earlier than the second reservation.

5. The information processing device according to claim 1, wherein the control unit is configured to generate information on a charge for the second user such that the charge for the second user increases as a time period gets longer, the time period being from an end point of a time frame corresponding to the first vehicle to a starting point of a time frame corresponding to the second vehicle.

6. The information processing device according to claim 1, further comprising:
a storage unit configured to store information on the predetermined facility corresponding to removal of the component from the first vehicle and installation of the component in the second vehicle.

7. The information processing device according to claim 6, wherein the storage unit is configured to store the possible reservation time of the predetermined facility.

8. The information processing device according to claim 6, wherein the storage unit is configured to store a time required for removing the component from the first vehicle and a time required for installing the component in the second vehicle.

9. The information processing device according to claim 1, wherein the component increases a performance of the second vehicle after the component is moved to the second vehicle in comparison to before the component is moved to the second vehicle.

10. The information processing device according to claim 1, wherein the component is a component installed in the first vehicle when the first vehicle is manufactured.

11. The information processing device according to claim 1, wherein the component is a component that is selectable as a factory-installed option when the first vehicle is purchased as a new vehicle.

12. An information processing method performed by a computer, the information processing method comprising:
acquiring a request from a first user to move a component included in a first vehicle from the first vehicle; and
determining, in response to a request from a second user to move the component to a second vehicle, a possible reservation time of a predetermined facility at which the component is to be moved based on the request from the first vehicle.

13. The information processing method according to claim 12, wherein the computer is configured to generate a paring of the first vehicle and the second vehicle.

14. The information processing method according to claim 12, wherein the computer is configured to:
generate information on a first reservation for reserving the predetermined facility at which the component is to be moved from the first vehicle; and
generate information on a second reservation for reserving the predetermined facility at which the component is to be moved to the second vehicle.

15. The information processing method according to claim 14, wherein the computer is configured to generate the information on the first reservation and the information on the second reservation such that the first reservation is earlier than the second reservation.

16. The information processing method according to claim 12, wherein the computer is configured to generate information on a charge for the second user such that the charge for the second user increases as a time period gets longer, the time period being from an end point of a time frame corresponding to the first vehicle to a starting point of a time frame corresponding to the second vehicle.

17. The information processing method according to claim 12, wherein the component is a component installed in the first vehicle when the first vehicle is manufactured.

18. The information processing method according to claim 12, wherein the component is a component that is selectable as a factory-installed option when the first vehicle is purchased as a new vehicle.

19. A non-transitory storage medium storing instructions that are executable by one or more processors and that cause the one or more processors to perform functions comprising:
acquiring a request from a first user to move a component included in a first vehicle from the first vehicle; and
determining, in response to a request from a second user to move the component to a second vehicle, a possible reservation time of a predetermined facility at which the component is to be moved based on the request from the first vehicle.

20. The non-transitory storage medium according to claim 19, wherein the component is a component installed in the first vehicle when the first vehicle is manufactured.
